(19) United States
(12) Patent Application Publication
(10) Pub. No.: US 2026/0094406 A1
(43) Pub. Date: Apr. 2, 2026

(54) FIXED-PATTERN NOISE CALIBRATION FOR SENSING SYSTEMS

(71) Applicant: Apple Inc., Cupertino, CA (US)

(72) Inventors: Gordon S. Franza, Rockledge, FL (US); Dale Setlak, Merritt Island, FL (US)

(21) Appl. No.: 19/295,614

(22) Filed: Aug. 9, 2025

Related U.S. Application Data
(60) Provisional application No. 63/700,525, filed on Sep. 27, 2024.

(51) Int. Cl. G06V 10/30; G06V 40/12; G06V 40/13

(52) U.S. Cl. CPC G06V 10/30; G06V 40/1306; G06V 40/1347

(57) ABSTRACT

Sensing element transducers in a sensing system are connected to sensing element electronics by a switchable averaging network. The switchable averaging network may be configured to cause the sensing elements to operate in a sensing mode where the sensing elements all operate independently or in a calibration mode where the connected sensing elements have as an input a uniform signal generated by combining signals from all of the interconnected sensing element transducers. Signals output from the sensing system in the calibration mode may differ from the uniform signal due to unstable FPN (fixed-pattern noise) generated by the sensing element electronics and readout channels. These differences may be derived by comparing the signals output from the sensing system in the calibration mode to the uniform signal, and may be used to reduce FPN.

### CROSS-REFERENCE TO RELATED APPLICATIONS

This application is a nonprovisional patent application of and claims the benefit of U.S. Patent Application No. 63/700,525, filed September 27, 2024 and titled “Fixed-Pattern Noise Calibration for Sensing Systems,” the disclosure of which is hereby incorporated herein by reference in its entirety.

### FIELD

The described embodiments relate generally to sensing systems. More particularly, the present embodiments relate to fixed-pattern noise calibration for sensing systems.

### BACKGROUND

There are a variety of different sensing systems. Such sensing systems include capacitive sensing systems, ultrasonic sensing systems, optical sensing systems, thermal sensing systems, and so on. For example, a capacitive sensing system may be used to detect touch, movement, proximity, pressure, force, among others. In some cases, a capacitive sensing system may be used to capture fingerprints, by generating one or more signals that may be used to derive images of fingerprints depicting ridges and valleys based on capacitive differences resulting from the relatively small differences in proximity of the respective surfaces of the fingertips.

Many sensing systems may be subject to noise. Sensing system noise may be the additive noise in the output of the process induced by a sensing system when measuring a variable. One type of noise is fixed-pattern noise (FPN). FPN is a term that identifies a temporally constant lateral non-uniformity (forming a constant pattern) in an imaging or other sensing system with multiple sensing, detector, or picture elements (pixels). FPN may be characterized by the same pattern of variation in pixel-brightness occurring in images taken under the same illumination conditions in a sensing array. This problem may arise from small differences in the individual responsivity of the sensing array that might be caused by variations in pixel size, material, or interference with circuitry. It might be affected by changes in the environment like different temperatures, exposure times, and so on.

### SUMMARY

The present disclosure relates to fixed-pattern noise calibration for sensing systems. Sensing element transducers may be connected to sensing element electronics by a switchable averaging network. The switchable averaging network may be configured to cause the sensing elements to operate in a sensing mode where the sensing elements all operate independently, or in a calibration mode where the connected sensing elements have as an input a uniform signal generated by combining signals from all of the interconnected sensing element transducers. Signals output from the sensing system in the calibration mode may differ from the uniform signal due to unstable FPN (fixed-pattern noise) generated by the sensing element electronics and readout channels. These differences may be derived by comparing the signals output from the sensing system in the calibration mode to the uniform signal, and may be used to reduce FPN.

In various embodiments, a system includes at least one contact material, a set of sensing element transducers adjacent the at least one contact material, a set of sensing element electronics, a switchable averaging network connected to the set of sensing element transducers and the set of sensing element electronics, wherein the switchable averaging network is activatable to combine signals from the set of sensing element transducers to generate a uniform signal that is provided to the set of sensing element electronics and de-activatable to allow the set of sensing element transducers and set of sensing element electronics to operate independently, and at least one processor. The at least one processor is configured to obtain at least one image using the set of sensing element electronics when the switchable averaging network is deactivated, obtain dynamic calibration data using the set of sensing element electronics when the switchable averaging network is activated, and use the dynamic calibration data to perform fixed-pattern noise reduction on the at least one image.

In some examples, the set of sensing element transducers includes conductive plates. In a number of examples, the at least one processor activates the switchable averaging network by closing at least one switch.

In various examples, the set of sensing element electronics include at least one amplifier. In some examples, the set of sensing element electronics include at least one multiplexing switch. In a number of examples, the system further includes at least one read out channel coupled to the set of sensing element electronics.

In some examples, the at least one image is at least one image of a fingerprint. In various implementations of such examples, the at least one image of the fingerprint is obtained while a finger is on the at least one contact material and the dynamic calibration data is obtained while the finger is on the at least one contact material.

In a number of examples, the at least one contact material is a dielectric. In various implementations of such examples, the dielectric includes an air gap.

In some embodiments, a sensing system includes at least one contact material, pixel transducers positioned to sense an object through the at least one contact material, pixel electronics, a switchable averaging network connected to the pixel transducers and the pixel electronics and including at least one switch that is operable to combine signals from the pixel transducers to generate a uniform signal that is provided to the pixel electronics and operable to allow the pixel transducers and pixel electronics to operate independently, at least one non-transitory storage medium that stores instructions, and at least one processor. The at least one processor executes the instructions to obtain at least one image of at least one fingerprint using the pixel electronics when the at least one switch is open and a finger associated with the at least one fingerprint is on the at least one contact material, close the at least one switch, obtain dynamic calibration data using the pixel electronics when the at least one switch is closed and the finger associated with the at least one fingerprint is on the at least one contact material, and use the dynamic calibration data to perform fixed-pattern noise reduction on the at least one image of the at least one fingerprint.

In various examples, the switchable averaging network is positioned between the pixel electronics and the at least one contact material. In some examples, the at least one switch includes a switch for each of the pixel transducers. In a number of examples, the sensing system is a button, the button defined on or positioned over the at least one contact material. In various examples, the sensing system is incorporated into a mobile electronic device.

In a number of embodiments, a method includes obtaining at least one image of at least one fingerprint using sensing element electronics of a sensing system when a switchable averaging network connecting the sensing element electronics of the sensing system to sensing element transducers of the sensing system is deactivated and a finger associated with the at least one fingerprint is on a contact material of the sensing system, activating the switchable averaging network, obtaining dynamic calibration data using the sensing element electronics when the switchable averaging network is activated and the finger associated with the at least one fingerprint is on the contact material of the sensing system, and using the dynamic calibration data to perform fixed-pattern noise reduction on the at least one image of the at least one fingerprint.

In various examples, the method further includes obtaining static calibration data when the finger associated with the at least one fingerprint is not on the contact material of the sensing system. In some implementations of such examples, the method further includes using the static calibration data to further perform fixed-pattern noise reduction on the at least one image of the at least one fingerprint.

In a number of examples, obtaining the at least one image of the at least one fingerprint includes collecting a sequence of video frames. In some implementations of such examples, obtaining the at least one image of the at least one fingerprint further includes selecting the at least one image of the at least one fingerprint from the sequence of video frames and processing the at least one image.

### BRIEF DESCRIPTION OF THE DRAWINGS

The disclosure will be readily understood by the following detailed description in conjunction with the accompanying drawings, wherein like reference numerals designate like structural elements.

FIG. 1 is a diagram illustrating an electronic device.

FIG. 2A depicts a first example sensing system.

FIG. 2B depicts a second example sensing system.

FIG. 3 depicts an example simplified circuit that may be used to implement a switchable averaging network.

FIG. 4A depicts a first probe calibration image from a fingerprint sensing system calibration showing FPN measured using the averaging network with the switching averaging network turned off.

FIG. 4B depicts a second probe calibration image from a fingerprint sensing system calibration showing FPN measured using the averaging network with the switching averaging network turned on.

FIG. 5A depicts a fingerprint image with ridges and valleys captured with the finger still on the sensing system and the switchable averaging network turned off.

FIG. 5B depicts an associated FPN image captured with the finger still on the sensing system and the switchable averaging network turned on.

FIG. 6 is a block diagram illustrating relationships among example components that may be used to implement the electronic device of FIG. 1.

FIG. 7 is a flow chart illustrating a first example method for FPN detection and/or reduction. This method may be performed by and/or using the electronic device and/or the sensing system of FIG. 1.

FIG. 8 is a flow chart illustrating a second example method for FPN detection and/or reduction. This method may be performed by and/or using the electronic device of FIG. 1 and/or the sensing systems of FIGS. 2A and 2B.

FIG. 9 is a flow chart illustrating a third example method for FPN detection and/or reduction. This method may be performed by and/or using the electronic device of FIG. 1 and/or the sensing systems of FIGS. 2A and 2B.

FIG. 10 is a flow chart illustrating a fourth example method for FPN detection and/or reduction. This method may be performed by and/or using the electronic device of FIG. 1 and/or the sensing systems of FIGS. 2A and 2B.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

Sensing systems, such as sensing systems in consumer electronic devices, may be required to work with low modulation ratio signals. This may make such sensing systems more vulnerable to noise than if they were not required to work with low modulation ratio signals.

By way of illustration, sensing systems used to generate images of fingerprints may be required to sense the fingerprints through protective glass, plastic, ceramic, or other covering materials used to form a cover. The covering materials may sometimes be as thick or thicker than the size of the fingerprint pattern features that must be resolved. As a result, while the average signal levels across the sensing array may be large, the difference between the signals at sensing elements (or pixel) adjacent to the fingerprint ridges and the signals at sensing elements adjacent to the fingerprint valleys may be quite small. These small signal differences may then define the features of interest in fingerprint matching. This difference may be called the Feature signal (F).

Fingerprint signals can be regarded as a form of spatial amplitude modulation. The strongest signal seen by the measuring sensing elements may be defined as the Carrier signal (C). The ratio of the feature signal difference to the carrier signal on the sensing array may be referred to as a spatial feature modulation ratio (FMR). The FMR may then be F / C. Feature modulation ratios for typical consumer fingerprint sensing system imaging through covering materials may range from approximately -10 dB to -50 dB.

This problem may be generally true in many types of fingerprint sensing systems, for example those using electric field sensing, capacitance sensing, ultrasonic sensing, and optical sensing.

Nonuniformities in the sensing surface and the readout electronics of a sensing system may introduce FPN. In a sensing system that is used to obtain images of fingerprints, the FPN may degrade the fingerprint image.

For example, fingerprint sensing systems may have amplifiers and/or switches connected to each sensing element transducer. In a semiconductor array, the gain of these amplifiers and switches may vary from sensing element to sensing element by several percent due to semiconductor process variability. In an example, fingerprint sensing system with an FMR of -40dB, a variation in the signals of 1% may be the same size as a fingerprint feature. Hence, the normal gain variation may seriously degrade the fingerprint image. This type of image degradation is called FPN.

FPN where the pattern is stable may be measured. That measurement then may be used in reducing the noise in subsequent images.

FPN signals that stay the same under all measurement conditions may be referred to as stable FPN. In these cases, the fixed pattern can be measured to generate static calibration data when a finger is not on the sensing system, such as in a calibration process. This static calibration data then may be used to compensate for the FPN, such as during fingerprint imaging. This static calibration process may be performed by a manufacturer at a factory prior to an electronic device ever being provided to a customer.

However, FPN may not always be sufficiently stable for static calibration to be effective. This may particularly be the case for high-accuracy fingerprint sensing systems.

In more sensitive devices, FPN may change with device temperature, signal levels, finger skin type, and device age. This may be referred to as unstable FPN. This instability may make noise cancellation using static calibration data (collected when the finger is not on the sensing system) inadequate for producing high quality fingerprint images.

The present disclosure provides mechanisms to capture specific unstable FPN calibration data, which may be performed in-line with standard imaging or other sensing sequences, for example while a finger is on a sensing system. This unstable FPN calibration data may vary from touch to touch, and may properly reflect the sensing system’s temperature, signal levels, the finger skin type, and device age.

The following disclosure relates to fixed-pattern noise calibration for sensing systems. Sensing element transducers may be connected to sensing element electronics by a switchable averaging network. The switchable averaging network may be configured to cause the sensing elements to operate in a sensing mode where the sensing elements all operate independently or in a calibration mode where the connected sensing elements have as an input a uniform signal generated by combining signals from all of the interconnected sensing element transducers. Signals output from the sensing system in the calibration mode may differ from the uniform signal due to unstable FPN generated by the sensing element electronics and readout channels. These differences may be derived by comparing the signals output from the sensing system in the calibration mode to the uniform signal, and may be used to reduce FPN.

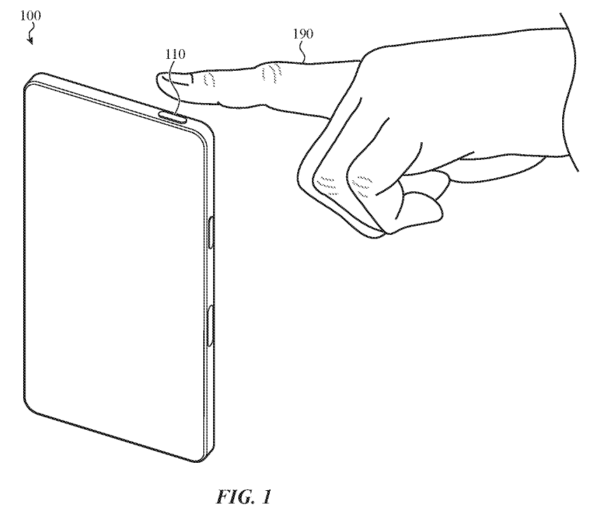

These and other embodiments are discussed below with reference to FIGS. 1 - 10. However, those skilled in the art will readily appreciate that the detailed description given herein with respect to these Figures is for explanatory purposes only and should not be construed as limiting.

FIG. 1 is a diagram illustrating an electronic device 100, which may be a mobile electronic device, a smart phone, a laptop computing device, a desktop computing device, earbuds, a printer, a display, a wearable device, smart glasses, and/or any other electronic device. The electronic device 100 may include a sensing system 110, which may include a button. The sensing system 110 may be used to detect touch, force, proximity, and so on of a finger 190 and/or other object. The sensing system 110 may also be used to obtain one or more images of the fingerprint of the finger 190. The sensing system 110 may be subject to FPN, whether stable FPN or unstable FPN. One or more techniques, discussed above and elaborated below, may be used to reduce this FPN.

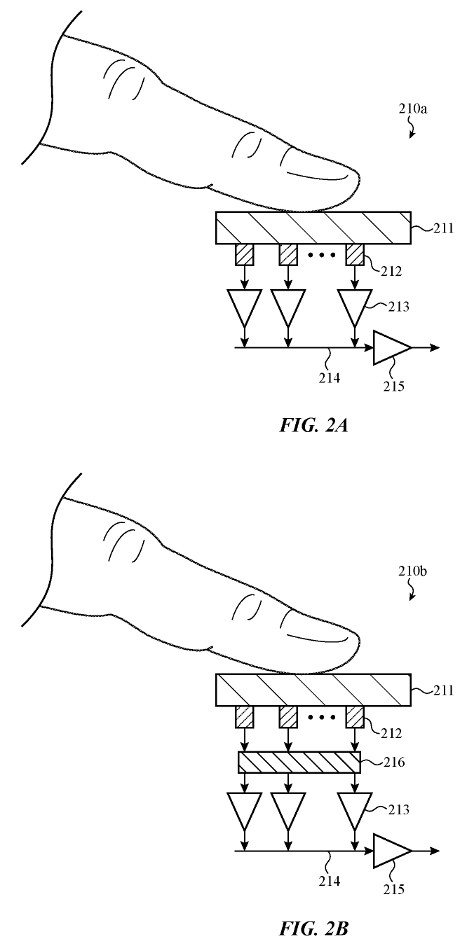

To reduce FPN for a sensing system, the FPN may first be decomposed into its component parts. The FPN in a sensing system, such as a fingerprint sensing system, may be generated by several components of the sensing system, such as the first example sensing system 210a of FIG. 2A.

The sensing system 210a may include one or more contact materials 211 (which may be called a cap and may protect one or more elements below), sets of sensing element transducers 212 (which may be metal, indium tin oxide, or other conductive plates), sets of sensing element electronics 213 (e.g. amplifiers and multiplexing switches), readout channels 214, and outputs 215. The contact material 211 may be a protective glass, plastic, metal, ceramic, or other covering materials used to form a cover, an air gap, and so on. In implementations where the sensing system 210 is capacitive, the contact material 211 may be a dielectric. In implementations where the sensing system 210 is ultrasonic, the contact material 211 may be a conductive material, such as metal, and the transducers 212 may be piezo electric materials rather than metal and/or other conductive material plates that may be used in implementations where the sensing system 210 is capacitive.

The different components of the FPN to which the sensing system 210a is subject may respond differently to changes in the operating environment (e.g., temperature, signal levels, and so on). This may make algorithmic adjustment of static calibration data ineffective for reducing the non-static components of FPN, or unstable FPN.

FIG. 2B depicts a second example sensing system 210b. The sensing system 210b may differ from the sensing system 210a at least by the interposition of a switchable averaging network 216 that connects the sensing element transducers 212 and the sensing element electronics 213. The switchable averaging network 216 may be used to provide a uniform input signal to the sensing element electronics 213 during a portion of the time that a finger contacts the contact material 211. This will be discussed in detail below.

To measure the FPN generated by the sensing element electronics 213 and the readout channels 214 separately from the other sources of FPN, the switchable averaging network 216 may be positioned upstream of the sensing element electronics 213. When the switchable averaging network 216 is switched on, all sensing element electronics 213 may have as input a uniform signal generated by combining the signals from all the interconnected sensing element transducers 212. In this configuration the output image captured may be a relatively pure measurement of the FPN generated by the sensing element electronics 213 and the readout channels 214. These two components of the FPN may often be quite sensitive to variation in the operating environment as discussed above. Hence the switchable averaging network 216 results may be effective in measuring and compensating for non-stable or unstable FPN.

An example of how a switchable averaging network, such as the switchable averaging network 216 discussed above, may be implemented for a sensing system, such as an electric field based fingerprint sensing system, will now be discussed.

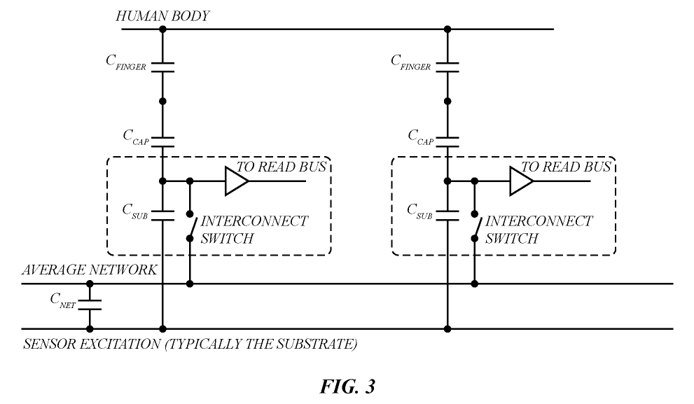

The sensing element transducers of the sensing system may be conductive plates that act as electric field detectors. To produce the switchable averaging network, analog switches may be configured to interconnect a group of sensing elements (including the sensing element transducers and the sensing element electronics) together into a switchable averaging network at the conductive plates. This bussed sensing element structure is illustrated in the example simplified circuit depicted in FIG. 3.

The example simplified circuit depicted in FIG. 3 is a diagrammatic representation of two sensing elements and the switchable averaging network. In this model, electrical field sensing elements are modeled for simplicity as capacitive voltage divider circuits. This simplification may be adequate for modeling FPN measurement and compensation and/or reduction mechanisms.

In this model, within the sensing elements, C_{FINGER} may represent the capacitance of the skin of a finger, C_{CAP} may represent the capacitance of the contact material (or cap), and C_{SUB} may represent the effective capacitance from a conductive plate to the excitation signal that may be on the substrate. In the overall sensing system array, C_{NET} may represent parasitic capacitance of conductors of the switchable averaging network to the substrate.

When the switches are open, each conducive plate and its under sensing element electronics may be independent. When the interconnect switches are closed, the under sensing element electronics of all connected sensing elements may have as input a uniform signal generated by combining the signals from all of the interconnected conductive plates. The resulting signals output from the sensing system may then contain the FPN generated by the sensing electronics and the readout channels. Variations from the fingerprint and variations from the contact material may be removed by the averaging circuits. This measured FPN pattern may then be used in several different ways to reduce the FPN in the fingerprint images when the switches are opened.

The bussed pixel structure used here as an averaging network may be used for other purposes. In some cases, this bussed pixel structure may be used as part of detecting a finger or other object and/or for other purposes.

By way of example, in a situation where a single power supply is used, the amplifiers shown of each sensing element may be direct current (DC) chopper stabilized differential amplifiers. Before an alternating current (AC) signal is applied to a sensing element, the amplifiers may be biased. The switchable averaging network (which may be functioning as a DC restore wire) may be used by closing only one of the switches associated with the sensing element to be measured before the sensing element is measured and applying a voltage source of half the excitation of the power supply (1.5v for a 3v power supply). Because the amplifiers are differential amplifiers, both sides of the amplifiers may be biased in this way, balancing the differential amplifiers. The AC signal may then be superimposed on the DC voltage. The DC voltage may stay stable while the AC current fluctuates. The sensing element may then be measured and the differential amplifier may be reset again before the next measurement. This may avoid the need for a feedback loop. A feedback loop, by way of contrast, may lower impedance. For some applications, an extremely high impedance may be desired.

Operation of the example simplified circuit of FIG. 3 will now be elaborated. When the switches are opened, the amplifiers may see a voltage with respect to the sensing system substrate determined by the voltage divider made up of the three series capacitors Cfinger, Ccap, and Csub. In fingerprint imaging mode, this model may represent the fingerprint image coming from local variation in the Cfinger capacitances of the ridges and valleys of the fingerprint. When the switches are closed, all of the Cfinger and Ccap strings are connected in parallel and all of the Csub capacitors are also connected in parallel with the Cinet parasitic capacitor. This may result in a uniform input signal to all the sensing element electronics. Variations in the measured sensing element voltages at the output of the sensing system may now represent FPN from the sensing element electronics and the readout channels.

In some cases, the switching averaging network may be used during an initial calibration, such as calibration at a factory during a manufacturing process. The switching averaging network may be activated during a portion of an initial calibration of the sensing system to help distinguish between FPN generated by the contact material and sensing element transducers and FPN generated by the sensing element electronics and the readout channels. This separation of sources may be particularly useful when the environmental effects are different for different components of the FPN. For example, calibration data measured at room temperature may now be better adapted for each FPN component for application at different operating temperatures.

Although FIG. 3 illustrates a specific configuration, it is understood that this is an example. In various implementations, other configurations may be used without departing from the scope of the present disclosure. By way of illustration, the above connects all of the Cfinger and Ccap strings in parallel and all of the Csub capacitors in parallel with the Cinet parasitic capacitor when the switches are closed but not when the switches are open. However, in other embodiments a different configuration could be used where all of the Cfinger and Ccap strings are connected in parallel and all of the Csub capacitors are connected in parallel with the Cinet parasitic capacitor when the switches are open but not when the switches are closed. Various configurations are possible and contemplated.

Further, although the above describes connecting all of the sensing elements of a sensing system with the switchable averaging network, it is understood that this is an example. In some implementations, groups of sensing elements of a sensing system may be connected via switchable averaging networks in separate sets of averaging groups. This may be done to be able to localize areas of FPN reduction, to conserve resources used to determine and/or reduce FPN, and so on. Various configurations are possible and contemplated without departing from the scope of the present disclosure.

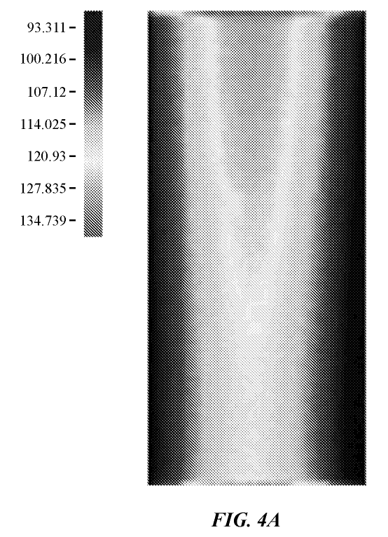

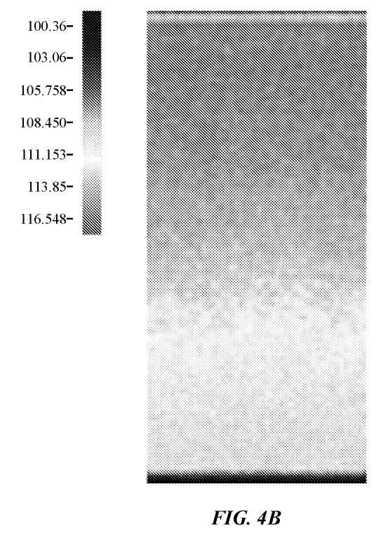

FIG. 4A depicts a first probe calibration image from a fingerprint sensing system calibration showing FPN measured using an averaging network with the switching averaging network turned off. FIG. 4B depicts a second probe calibration image from a fingerprint sensing system calibration showing FPN measured using the averaging network with the switching averaging network turned on. The FPN in these probe calibration images may be depicted as the fine grained speckling. It is noted that FIGS. 4A and 4B illustrate different units, microvolts and millivolts.

The FPN may be extracted from the first probe calibration image of FIG. 4A using image processing filters. However, during fingerprint imaging, the pattern may change due to different temperatures and different finger properties.

FPN may also be measured on the fly during fingerprint imaging. One way to handle variations in FPN due to temperature, signal levels, finger skin type, and device age is to measure the FPN as close as possible to the same time and conditions as when the fingerprint image data is collected. The averaging network may allow the FPN data to be collected while the finger is on the sensing system, either before or after fingerprint image data, and in some cases with every measurement frame of fingerprint image data. By averaging out the fingerprint pattern, the switchable averaging network provides unstable FPN calibration data that best matches that included in the fingerprint image.

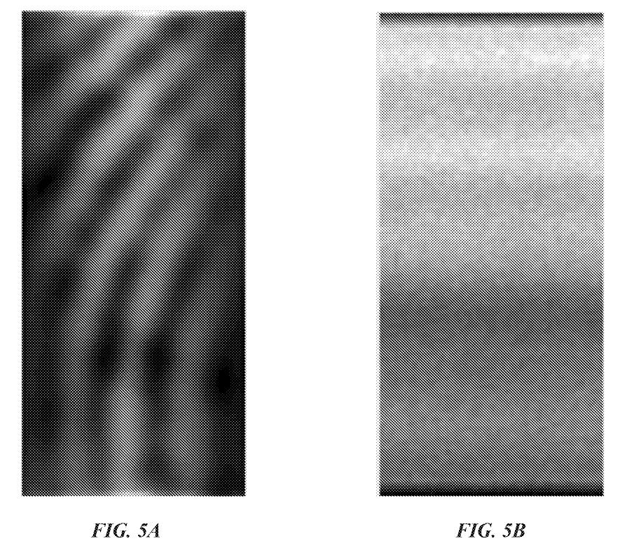

FIG. 5A depicts a fingerprint image with ridges and valleys captured with the finger still on the sensing system and the switchable averaging network turned off. FIG. 5B depicts an associated FPN image captured with the finger still on the sensing system and the switchable averaging network turned on. The FPN in FIGS. 5A and 5B may be the fine grained speckling. The FPN visible in the fingerprint image of FIG. 5A may degrade the ability of the sensing system to extract clean edges between the ridges and valleys of the fingerprint. The associated FPN image of FIG. 5B captured with the switchable averaging network turned on averages out the ridge and valley pattern of the fingerprint, leaving the FPN extractable in order to be used to reduce the FPN in the fingerprint image of FIG. 5A.

One or more FPN measurement frames may be inserted into an image frame sequence. In an example implementation, a fingerprint pattern may be collected as a sequence of video frames that back-end image processing may analyze. For example, the sensing system may select the best frame for further use. Alternatively, the sensing system may average several frames to produce the best image for subsequent processing, combine several frames to produce the best image for subsequent processing, and so on. For FPN reduction as discussed herein, the sensing system may insert a calibration frame (using the switchable averaging network) within the sequence of video frames.

The data generated using the switchable averaging network measurement obtained by activating the switchable averaging network may be used in a variety of different methods. In some implementations, some such methods may be used to improve fingerprint image quality. For example, a compensating algorithm may extract the FPN from an image with the switchable averaging network turned on, scale and normalize that FPN, and apply the results to reduce the FPN in a fingerprint image captured with the switchable averaging network turned off. However, it is understood that this is an example. Other schemes, which may be more elaborate, may be used to take advantage of the information contained in the data captured with the switchable averaging network turned on.

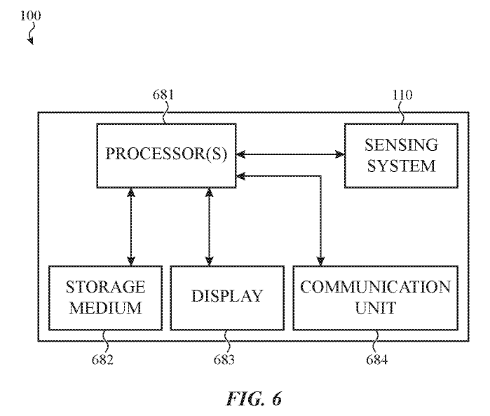

FIG. 6 is a block diagram illustrating relationships among example components that may be used to implement the electronic device 100 of FIG. 1. The electronic device 100 may include one or more processors 681 and/or other processing units or controllers, one or more non-transitory storage media 682 (which may take the form of, but is not limited to, a magnetic storage medium; optical storage medium; magneto-optical storage medium; read only memory; random access memory; erasable programmable memory; flash memory; and so on), one or more displays 683, one or more sensing systems 110, one or more communication units 684 (such as one or more network adapters), and so on.

The processor 681 may execute one or more instructions stored in the storage medium 682 to perform one or more functions. Such functions may include instructing operation of the sensing system 110, evaluating one or more signals form the sensing system 110, reducing FPN in one or more images captured using the sensing system 110, and so on.

Although FIG. 6 illustrates a specific configuration, it is understood that this is an example. In other implementations, other configurations may be used without departing from the scope of the present disclosure. By way of example, in some implementations, the processor 681 and the sensing system 110 may be incorporated into different electronic devices. Various configurations are possible and contemplated without departing from the scope of the present disclosure.

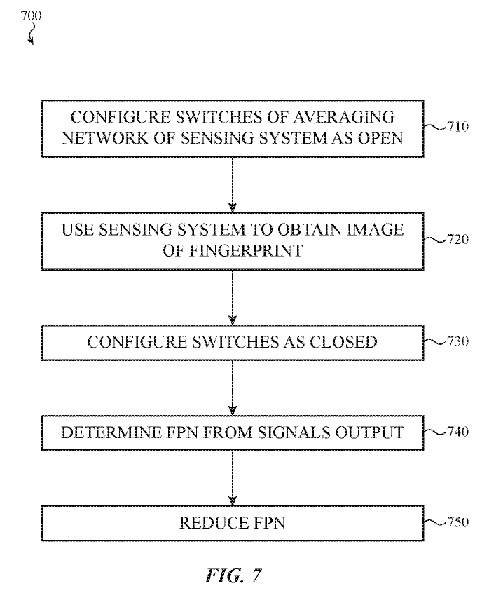

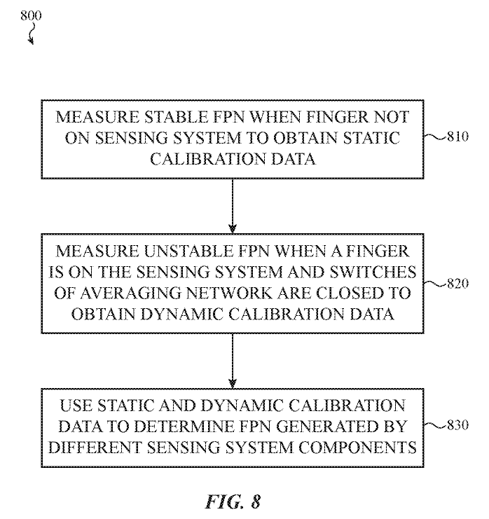

FIG. 7 illustrates a first example method 700 for FPN detection and/or reduction. The method 700 may be performed by the electronic device 100 and/or the sensing system 110 of FIG. 1.

At operation 710, a device (such as the electronic device 100 and/or the sensing system 110 of FIG. 1) may configure switches of the switchable averaging network of the sensing system as open. Configuring the switches of the switchable averaging network of the sensing system as open may deactivate the switchable averaging network to disconnect sensing elements of the sensing system and allow the sensing elements to operate independently. Configuring the switches as open may include changing the switches from closed to open, allowing the switches that are already open to remain so, and so on.

At operation 720, the device may use the sensing system to obtain one or more images of one or more fingerprints. In some examples, the one or more images of one or more fingerprints may be captured as part of a sequence of frames of video.

At operation 730, the device may configure the switches as closed. Configuring the switches as closed may activate the switchable averaging network to connect sensing elements of the sensing system. Configuring the switches as open may include changing the switches from closed to open, allowing the switches that are already closed to remain so, and so on.

At operation 740, the device may determine FPN from one or more signals output by the sensing system. The one or more signals may be produced while a finger is on the sensing system and the switchable averaging network is activated.

At operation 750, the device may reduce FPN. The device may reduce FPN in one or more of the one or more images of the one or more fingerprints using the FPN determined in operation 740.

Although the example method 700 is illustrated and described as including particular operations performed in a particular order, it is understood that this is an example. In various other implementations, various orders of the same, similar, and/or different operations may be performed without departing from the scope of the present disclosure.

For example, the above references configuring the switches of the switchable averaging network as closed to activate the switchable averaging network and as open to deactivate the switchable averaging network. However, it is understood that this is an example. In other implementations, the switches may be opened to deactivate the switchable averaging network and closed to activate the switchable averaging network. In still other implementations, mechanisms other than switches may be used to activate and/or deactivate the switchable averaging network. Various configurations are possible and contemplated.

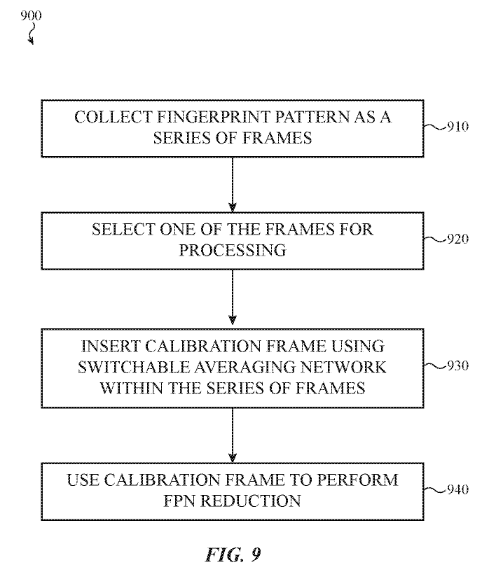

FIG. 8 illustrates a second example method 800 for FPN detection and/or reduction. The method 800 may be performed by the electronic device 100 and/or the sensing system 110 of FIG. 1.

At operation 810, a device (such as the electronic device 100 and/or the sensing system 110 of FIG. 1) may measure stable FPN when a finger is not on a sensing system to obtain static calibration data. The static calibration data may be used as part of an initial calibration process.

At operation 820, the device may measure unstable FPN when a finger is on the sensing system and switches of a switchable averaging network are closed to obtain dynamic calibration data. Closing the switches of the switchable averaging network may activate the switchable averaging network.

At operation 830, the device may use static and dynamic calibration data to determine FPN generated by different sensing system components. The device may use the static and dynamic calibration data together and/or separately to determine the FPN.

Although the example method 800 is illustrated and described as including particular operations performed in a particular order, it is understood that this is an example. In various implementations, various orders of the same, similar, and/or different operations may be performed without departing from the scope of the present disclosure.

For example, in some implementations the method may further include mitigating and/or otherwise reducing FPN. Various configurations are possible and contemplated without departing from the scope of the present disclosure.

FIG. 9 illustrates a third example method 900 for FPN detection and/or reduction. The method 900 may be performed by the electronic device 100 and/or the sensing system 110 of FIG. 1.

At operation 910, a device (such as the electronic device 100 and/or the sensing system 110 of FIG. 1) may collect one or more fingerprint patterns as a series of frames, such as in a series of frames of a video. At operation 920, the device may select one of the frames for processing. The device may select the frame that the device determines to be of the best quality, such as where the edges between ridges and valleys are most clear. At operation 930, the device may insert one or more calibration frames using a switchable averaging network within the series of frames. At operation 940, the device may use the one or more calibration frames to perform FPN reduction.

Although the example method 900 is illustrated and described as including particular operations performed in a particular order, it is understood that this is an example. In various implementations, various orders of the same, similar, and/or different operations may be performed without departing from the scope of the present disclosure.

For example, operation 930 is illustrated and described as inserting one or more calibration frames using a switchable averaging network within the series of frames. However, it is understood that this is an example. In various implementations, the one or more calibration frames may be kept separate from the series of frames. Various configurations are possible and contemplated without departing from the scope of the present disclosure.

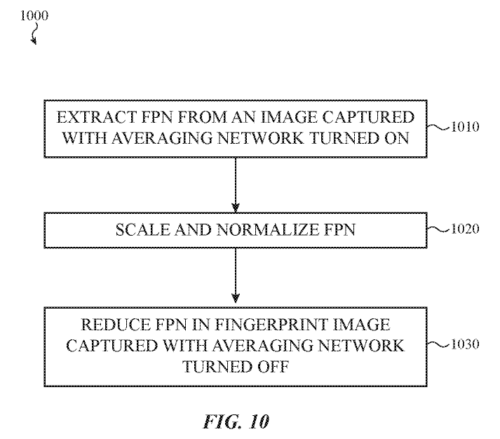

FIG. 10 illustrates a fourth example method 1000 for FPN detection and/or reduction. The method 1000 may be performed by the electronic device 100 and/or the sensing system 110 of FIG. 1.

At operation 1010, a device (such as the electronic device 100 and/or the sensing system 110 of FIG. 1) may extract FPN from an image captured with an averaging network turned on. The averaging network may be a switchable averaging network.

At operation 1020, the device may scale and/or normalize the extracted FPN.

At operation 1030, the device may reduce the FPN in the fingerprint image captured with the averaging network turned off. The device may reduce the FPN using the scaled and normalized extracted FPN.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described above as scaling and normalizing FPN. However, it is understood that this is an example. In various implementations, one or more of these operations may be omitted. Various configurations are possible and contemplated without departing from the scope of the present disclosure.

The present disclosure is illustrated and described as applied to electric field sensing systems. However, the techniques of the present disclosure may be applied equally to other sensing systems without departing from the scope of the present disclosure.

In various implementations, a system may include at least one contact material, a set of sensing element transducers adjacent the at least one contact material, a set of sensing element electronics, a switchable averaging network connected to the set of sensing element transducers and the set of sensing element electronics, wherein the switchable averaging network is activatable to combine signals from the set of sensing element transducers to generate a uniform signal that is provided to the set of sensing element electronics and de-activatable to allow the set of sensing element transducers and set of sensing element electronics to operate independently, and at least one processor. The at least one processor may be configured to obtain at least one image using the set of sensing element electronics when the switchable averaging network is deactivated, obtain dynamic calibration data using the set of sensing element electronics when the switchable averaging network is activated, and use the dynamic calibration data to perform fixed-pattern noise reduction on the at least one image.

In some examples, the set of sensing element transducers may include conductive plates. In a number of examples, the at least one processor may activate the switchable averaging network by closing at least one switch.

In various examples, the set of sensing element electronics may include at least one amplifier. In some examples, the set of sensing element electronics may include at least one multiplexing switch. In a number of examples, the system may further include at least one read out channel coupled to the set of sensing element electronics.

In some examples, the at least one image may be at least one image of a fingerprint. In various such examples, the at least one image of the fingerprint may be obtained while a finger is on the at least one contact material and the dynamic calibration data may be obtained while the finger is on the at least one contact material.

In a number of examples, the at least one contact material may be a dielectric. In various such examples, the dielectric may include an air gap.

In some implementations, a sensing system may include at least one contact material, pixel transducers positioned to sense an object through the at least one contact material, pixel electronics, a switchable averaging network connected to the pixel transducers and the pixel electronics and including at least one switch that is operable to combine signals from the pixel transducers to generate a uniform signal that is provided to the pixel electronics and operable to allow the pixel transducers and pixel electronics to operate independently, at least one non-transitory storage medium that stores instructions, and at least one processor. The at least one processor may execute the instructions to obtain at least one image of at least one fingerprint using the pixel electronics when the at least one switch is open and a finger associated with the at least one fingerprint is on the at least one contact material, close the at least one switch, obtain dynamic calibration data using the pixel electronics when the at least one switch is closed and the finger associated with the at least one fingerprint is on the at least one contact material, and use the dynamic calibration data to perform fixed-pattern noise reduction on the at least one image of the at least one fingerprint.

In various examples, the switchable averaging network may be positioned between the pixel electronics and the at least one contact material. In some examples, the at least one switch may include a switch for each of the pixel transducers. In a number of examples, the sensing system may be a button, the button defined on or positioned over the at least one contact material. In various examples, the sensing system may be incorporated into a mobile electronic device.

In a number of embodiments, a method may include obtaining at least one image of at least one fingerprint using sensing element electronics of a sensing system when a switchable averaging network connecting the sensing element electronics of the sensing system to sensing element transducers of the sensing system is deactivated and a finger associated with the at least one fingerprint is on a contact material of the sensing system, activating the switchable averaging network, obtaining dynamic calibration data using the sensing element electronics when the switchable averaging network is activated and the finger associated with the at least one fingerprint is on the contact material of the sensing system, and using the dynamic calibration data to perform fixed-pattern noise reduction on the at least one image of the at least one fingerprint.

In various examples, the method may further include obtaining static calibration data when the finger associated with the at least one fingerprint is not on the contact material of the sensing system. In some such examples, the method may further include using the static calibration data to further perform fixed-pattern noise reduction on the at least one image of the at least one fingerprint.

In a number of examples, obtaining the at least one image of the at least one fingerprint may further include collecting a sequence of video frames. In some such examples, obtaining the at least one image of the at least one fingerprint may further include selecting the at least one image of the at least one fingerprint from the sequence of video frames and processing the at least one image.

As described above and illustrated in the accompanying figures, the present disclosure relates to fixed-pattern noise calibration for sensing systems. Sensing element transducers may be connected to sensing element electronics by a switchable averaging network. The switchable averaging network may be configured to cause the sensing elements to operate in a sensing mode where the sensing elements all operate independently or in a calibration mode where the connected sensing elements have as an input a uniform signal generated by combining signals from all of the interconnected sensing element transducers. Signals output from the sensing system in the calibration mode may differ from the uniform signal due to unstable FPN generated by the sensing element electronics and readout channels. These differences may be derived by comparing the signals output from the sensing system in the calibration mode to the uniform signal, and may be used to reduce FPN.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

As described above, one aspect of the present technology is sensing images (such as fingerprints), and the like. The present disclosure contemplates that in some instances this gathered data may include personal information data that uniquely identifies or can be used to contact or locate a specific person. Such personal information data can include demographic data, location-based data, telephone numbers, email addresses, handles (or other social media aliases), home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide haptic or audiovisual outputs that are tailored to the user. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of determining spatial parameters, the present technology can be configured to allow users to select to "opt in" or "opt out" of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, haptic outputs may be provided based on non-personal information data or a bare minimum amount of personal information, such as events or states at the device associated with a user, other non-personal information, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
at least one contact material;
a set of sensing element transducers adjacent the at least one contact material;
a set of sensing element electronics;
a switchable averaging network connected to the set of sensing element transducers and the set of sensing element electronics, wherein the switchable averaging network is:
activatable to combine signals from the set of sensing element transducers to generate a uniform signal that is provided to the set of sensing element electronics; and
de-activatable to allow the set of sensing element transducers and set of sensing element electronics to operate independently; and
at least one processor configured to:
obtain at least one image using the set of sensing element electronics when the switchable averaging network is deactivated;
obtain dynamic calibration data using the set of sensing element electronics when the switchable averaging network is activated; and
use the dynamic calibration data to perform fixed-pattern noise reduction on the at least one image.

2. The system of claim 1, wherein the set of sensing element transducers comprises conductive plates.

3. The system of claim 1, wherein the at least one processor activates the switchable averaging network by closing at least one switch.

4. The system of claim 1, wherein the set of sensing element electronics include at least one amplifier.

5. The system of claim 1, wherein the set of sensing element electronics include at least one multiplexing switch.

6. The system of claim 1, further comprising at least one read out channel coupled to the set of sensing element electronics.

7. The system of claim 1, wherein the at least one image is at least one image of a fingerprint.

8. The system of claim 7, wherein:
the at least one image of the fingerprint is obtained while a finger is on the at least one contact material; and
the dynamic calibration data is obtained while the finger is on the at least one contact material.

9. The system of claim 1, wherein the at least one contact material comprises a dielectric.

10. The system of claim 9, wherein the dielectric comprises an air gap.

11. A sensing system, comprising:
at least one contact material;
pixel transducers positioned to sense an object through the at least one contact material;
pixel electronics;
a switchable averaging network connected to the pixel transducers and the pixel electronics and including at least one switch that is:
operable to combine signals from the pixel transducers to generate a uniform signal that is provided to the pixel electronics; and
operable to allow the pixel transducers and pixel electronics to operate independently;
at least one non-transitory storage medium that stores instructions; and
at least one processor that executes the instructions to:
obtain at least one image of at least one fingerprint using the pixel electronics when the at least one switch is open and a finger associated with the at least one fingerprint is on the at least one contact material;
close the at least one switch;
obtain dynamic calibration data using the pixel electronics when the at least one switch is closed and the finger associated with the at least one fingerprint is on the at least one contact material; and
use the dynamic calibration data to perform fixed-pattern noise reduction on the at least one image of the at least one fingerprint.

12. The sensing system of claim 11, wherein the switchable averaging network is positioned between the pixel electronics and the at least one contact material.

13. The system of claim 11, wherein the at least one switch comprises a switch for each of the pixel transducers.

14. The sensing system of claim 11, wherein the sensing system comprises a button, the button defined on or positioned over the at least one contact material.

15. The sensing system of claim 11, wherein the sensing system is incorporated into a mobile electronic device.

16. A method, comprising:
obtaining at least one image of at least one fingerprint using sensing element electronics of a sensing system when a switchable averaging network connecting the sensing element electronics of the sensing system to sensing element transducers of the sensing system is deactivated and a finger associated with the at least one fingerprint is on a contact material of the sensing system;
activating the switchable averaging network;
obtaining dynamic calibration data using the sensing element electronics when the switchable averaging network is activated and the finger associated with the at least one fingerprint is on the contact material of the sensing system; and
using the dynamic calibration data to perform fixed-pattern noise reduction on the at least one image of the at least one fingerprint.

17. The method of claim 16, further comprising obtaining static calibration data when the finger associated with the at least one fingerprint is not on the contact material of the sensing system.

18. The method of claim 17, further comprising using the static calibration data to further perform fixed-pattern noise reduction on the at least one image of the at least one fingerprint.

19. The method of claim 16, wherein obtaining the at least one image of the at least one fingerprint comprises collecting a sequence of video frames.

20. The method of claim 19, wherein obtaining the at least one image of the at least one fingerprint further comprises:
selecting the at least one image of the at least one fingerprint from the sequence of video frames; and
processing the at least one image.
